(19) United States
(12) Patent Application Publication
(10) Pub. No.: US 2004/0175243 A1
(43) Pub. Date: Sep. 9, 2004

(54) Chamfered blocks

(76) Inventor: Horacio Correia, Lachenaie (CA)

Correspondence Address: GOUDREAU GAGE DUBUC, 800 PLACE VICTORIA, SUITE 3400, MONTREAL, QUEBEC, H4Z 1E9, CA

(21) Appl. No.: 10/788,365

(22) Filed: Mar. 1, 2004

Related U.S. Application Data
(60) Provisional application No. 60/452,052, filed on Mar. 6, 2003.

(51) Int. Cl. E02D 29/00; B28B 3/00

(52) U.S. Cl. 405/284; 264/31; 264/333; 249/121; 249/122; 52/609

(57) ABSTRACT

A concrete block for the construction of retaining walls molded in a vertical position. The block having a width formed between a base and a forming shoe, a height formed between fixed opposite walls of a mold. The mold includes a mobile base member, a mobile intermediate closed form and a mobile top member. The mobile intermediate closed form is positioned on the base member to receive concrete therein and the top member is positioned on the intermediate closed form. A method for molding a concrete construction block for the construction of retaining walls in a vertical position, comprising providing a base and a shoe form, sitting a fixed closed form onto the base, molding concrete into the fixed closed form onto the base, and unmolding;

### FIELD OF THE INVENTION

The present invention relates to precast blocks for the construction of retaining walls and the like. More specifically, the present invention is concerned with chamfered concrete blocks, a mold therefor, a method of making such blocks.

### BACKGROUND OF THE INVENTION

Precast concrete construction blocks used for the erection of retaining walls are conventionally fabricated in a lying position. As is well known in the art, a concrete material is poured in a mold having many spaces for making a number of blocks at the same time. Once the concrete material has filled the mold, a pressing shoe is lowered, under hydraulic pressure for example, to compress the concrete material. A green shape is then completely solidified by curing.

Blocks as described above are commonly made in sets of two blocks as a unitary shape. These blocks are made in a side by side lying position, with each block being a mirror image of the other. Once made, the blocks are separated by percussion along a predefined break-off line.

FIG. 1 of the appended drawings illustrates a block as known in the art. The block 10 is formed as an elongated rectangular structure having opposite top and bottom faces, 12 and 14 respectively, as well as front and rear end surfaces, 16 and 18 respectively. Chamfers 20, 22 are provided in the top and bottom faces 12 and 14, respectively. These chamfers 20, 22 are disposed in an offset relationship, so as to receive a connector (not shown) between overlying chamfers when blocks 10 are stacked one on top of the other to form the retaining wall, thereby preventing a transverse displacement of the blocks. As is known in the art, the blocks may be stacked to erect a retaining wall having a backwardly inclined front face for greater stability.

The block 10 is conventionally molded in a horizontal position. Hence, pressure exerted by the forming shoe determines the height h of block 10. As such, height tolerance is not easily controllable, since it depends on a number of parameters that are difficult to control, such as the degree of homogeneity and density of the concrete material, the tolerance of rapidly moving hydraulic pressing shoes, the shrinking upon curing as well as other factors known to the skilled artisan. This variation in the height of blocks is oftentimes problematic when erecting a wall of a desired planarity. As such, landscaping contractors are often forced to hand-pick blocks in order to achieve a horizontal wall.

Heretofore, it was unknown to make chamfered blocks molded in a vertical orientation as opposed to a horizontal orientation.

### SUMMARY OF THE INVENTION

In one aspect, the present invention, provides a precast block molded in a vertical position, the block comprising a width formed between the base of a mold and a forming shoe, a height formed between fixed opposite walls of a mold.

In accordance with another aspect of the present invention there provided a concrete block comprising:

a top face and a bottom face of a generally trapezoidal shape, the top face and said bottom face having a width decreasing from a nominal width w of the block at a rear end surface thereof to a reduced width w′ at an edge of a rim extending to a front end surface of the block and having a length corresponding to the nominal width w of the block.

In accordance with a further aspect of the present invention there is provided a mold for molding block, the mold comprising:

a mobile base member;

a mobile intermediate closed form for positioning on the base member so as to receive concrete therein, said intermediate closed form including opposite walls; and

a mobile top member opposite the base member for positioning on the intermediate closed form so as to apply pressure to concrete contained therein;

whereby, when the intermediate closed form is positioned on the base member and contains concrete therein with the top member positioned thereon and when the concrete cools down, concrete blocks are formed of a width defined between the top member and said base member and of a height defined by the closed form opposite walls.

In accordance with yet another aspect of the present invention there is provided a method for molding a concrete construction block for the construction of retaining walls in a vertical position, comprising:

providing a base and a shoe form;

sitting a fixed closed form onto the base;

molding concrete into the fixed closed form onto the base; and

unmolding.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1, which is labeled prior art, is a side view of a concrete precast block according to the prior art;

FIG. 2 is an elevational view of a block according to an embodiment of a first aspect of the present invention;

FIG. 3 is an exploded view of a mold to produce the block of FIG. 2, according to a second aspect of the present invention;

FIG. 4 is a sectional view along the line 4-4 of FIG. 3;

FIG. 5 is a view of a row of blocks as seen in the direction 5 of FIG. 3;

FIG. 6 is a view of a row of blocks as seen in the direction 6 of FIG. 3;

FIG. 7 is a flowchart of a method to produce blocks using the mold of FIG. 3, according to a third aspect of the present invention;

FIG. 8 is a top view of a portion of a straight wall made with blocks of the present invention;

FIG. 9 is a top view of a portion of a slightly curved wall made with blocks of the present invention; and

FIG. 10 is a top view of a portion of a curved wall made with blocks of the present invention.

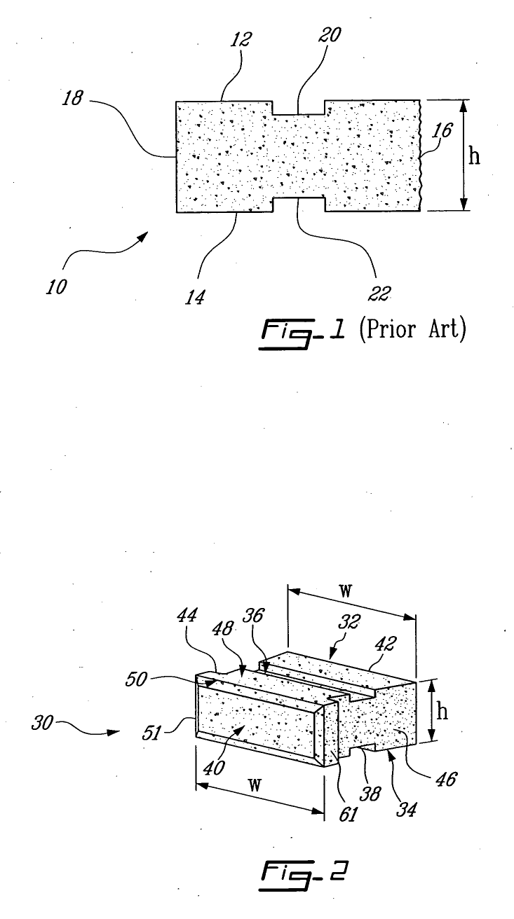

### DESCRIPTION OF THE EMBODIMENTS

Embodiments of the invention will now be described so as to exemplify the invention only and not limit the scope thereof.

Generally stated, the present invention provides blocks, and a method and a mold for the production thereof in a vertical position.

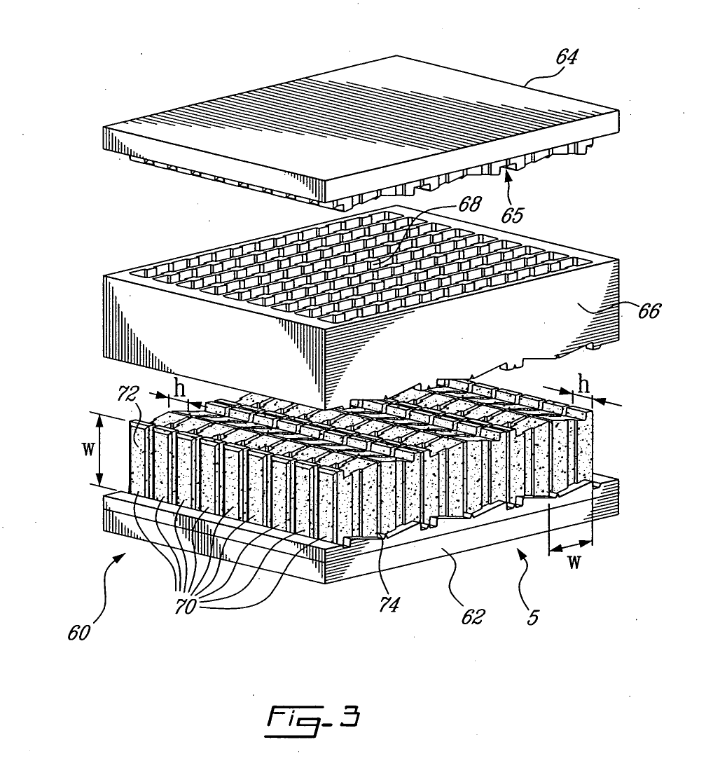

In relation to FIG. 2 of the appended drawings, a concrete precast block according to a one aspect of the present invention will now be described.

Block 30 includes top and bottom faces 32 and 34 respectively, a front end and a rear end surface 40 and 42 respectively and opposite side faces 44 and 46 respectively. Each face 32 and 34 is provided with a respective elongated connector receiving recess 36 and 38.

The top and bottom faces, 32 and 34, have a generally trapezoidal shape, with a width decreasing, at about a 45° angle, for example, from a nominal width w of the block 30 at the rear end surface 42 to a reduced width w′ at an edge 48, while in a rim 50 located between the edge 48 and the front end surface 40 they have a constant width w corresponding to the nominal width w of the block 30.

The above-described profile of the top and bottom faces 32 and 34 results in the block 30 having a chamfered shape instead of a massive filled rectangular shape. Therefore, when seen either from the front end or rear end surfaces 40 and 42, block 30 has an appearance similar to that of block 10, with a nominal width w, which corresponds to the width of the front end surface 40 and of the rear end surface 42. Furthermore, the weight of the block 30 is reduced compared to that of the block 10 since less material is needed.

Moreover, when blocks 30 are adjacently mounted along sides 51 of their respective rims 50 and stacked along their respective top and bottom faces 32 and 34 to form a wall, vertical channels are thus formed between columns of adjacent blocks 30. The vertical channels run all the way along the height of the formed wall and, once the blocks are installed as a wall structure, provide for drainage of water. The vertical channels also allow for using less concrete material. The skilled artisan will appreciate that these features improve the resistance of the wall to adverse climatic conditions such as freezing temperatures or heavy rainfall.

Turning now to another aspect of the present invention, a mold for producing such a block as described hereinabove will be described with reference to FIGS. 3 to 6.

As illustrated in FIG. 3, a mold 60 according to an embodiment of this aspect of the present invention comprises a mobile base member 62 opposite a mobile top member or shoe form 64, and fitting side walls formed by a side form 66.

Base member 62 is provided with a predefined shape corresponding to the sides of the blocks being molded. Once molded and pressed, shoe form 64 is raised or slid sideways, side form 66 is also raised, and mobile base 62 is slid sideways to allow complete unmolding of the blocks. This will be further explained below.

The base 62 and the shoe form 64 are both vertically and horizontally mobile. The closed form 66 is vertically mobile so than it can be lowered to sit onto the base 62 to form a container in which concrete is poured before the shoe form 64 is vertically lowered thereupon.

Both the base 62 and the shoe form 64 (see surface 65 for example) are provided with a desired chamfered geometry to imprint a corresponding desired chamfered geometry onto the concrete.

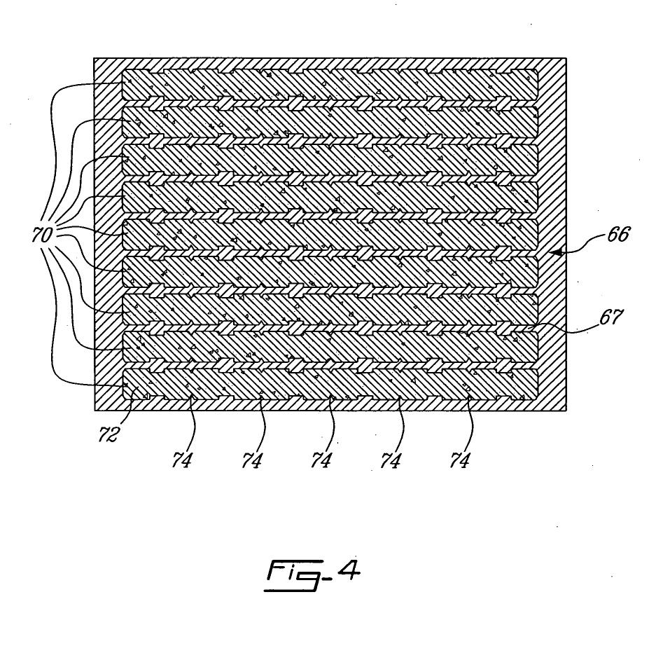

As is better seen in FIG. 4, the closed form 66 is characterized by an inside geometry defining a mesh 67 which provides for rows 70 of concrete forms 72 defined between successive notches 74. In this non-limiting specific example there are nine rows 70 of six concrete forms 72.

Once the concrete is poured into the container formed by the closed form 66 sitting on the base 62, the shoe form 64 is lowered to apply pressure to the concrete.

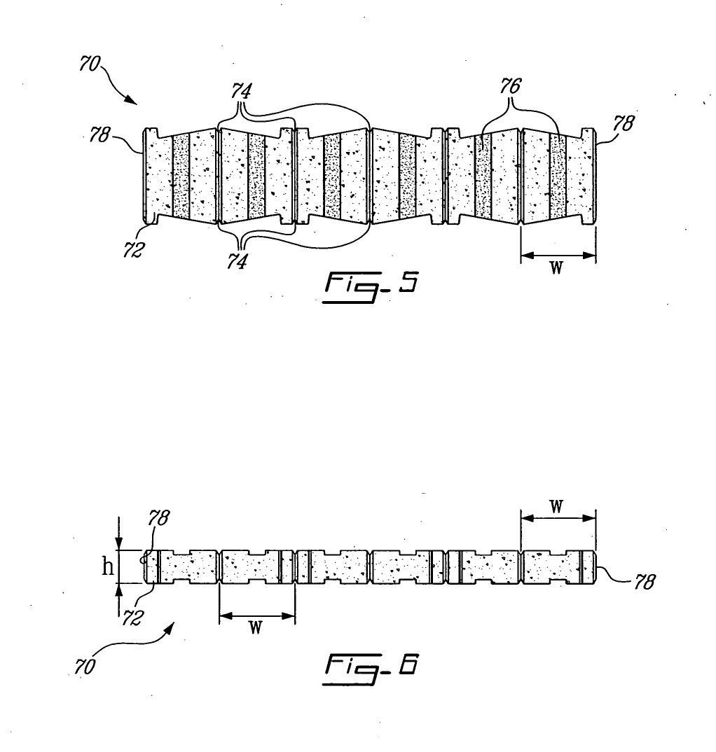

For unmolding, both the base 62 and the shoe form 64 are laterally removed by a horizontal movement. Alternatively, shoe form 64 can be lifted. The closed form 66 is lifted to allow for easy unmolding of the concrete, yielding, in this example, nine rows 70 of six concrete forms 72 corresponding to the mesh 67 (see FIGS. 5-6 further described hereinbelow).

As can be understood by FIGS. 2, 3 and 4, concrete blocks 30 are fabricated in a vertical position. Hence, the width w of a block 30 is determined between the base 62 and the shoe form 64, while its height h is determined between opposite walls of the closed form 66.

Specifically, rows 70 of concrete forms 72 (such as the rows illustrated in the side view of FIG. 5 and in the top view of FIG. 6) are demolded by first laterally removing both the base 62 and the shoe form 64 by a horizontal movement and then by lifting the closed form 66. Individual blocks are then obtained by separating each row 70 by percussion at notches 74. It should be noted that the finish of the end faces 78 of a row 70 is determined by the opposite walls of the closed form 66. The aforementioned finish may be further altered according to methods known in the art so as to yield a desired look for each individual block.

In an embodiment, at least one of each inner faces includes at least one horizontally retractable rod for forming at least one channel on the faces of the concrete blocks separated by the width.

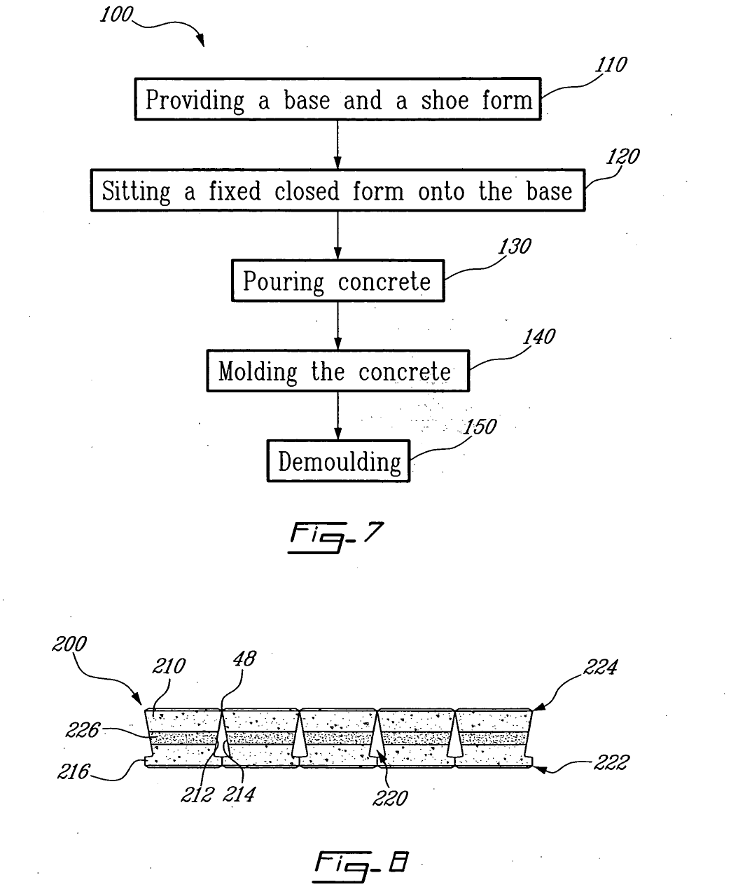

Turning now to FIG. 7, a method to produce a block according to a further aspect of the present invention, will be described.

The method 100 according to an embodiment comprises providing a base and a shoe form (step 110); sitting a fixed closed form onto the base (step 120); pouring concrete into the fixed closed form sitting on the base (step 130); molding the concrete (step 140); and unmolding (step 150).

In step 110, the base and the shoe form are respectively provided with adequate inner surfaces so as to imprint a desired chamfered shape. The shoe form is to be allowed to move up and down, by a hydraulic mechanism as is known in the art for example. Both the base and the shoe form are provided with a mechanism, such as guiding racks for example, to allow them to be moved in a generally horizontal plane.

The closed form provided in step 120 is designed to form a mesh comprising lateral walls of a mold comprising the base and the shoe form together with the closed form, and inner walls defining rows of blocks that are to be molded.

Concrete may be poured from above, usually in a thixotropic state that allows a controlled pouring (step 130).

Once the concrete is poured into the mold that is formed by the closed form sitting on the base, the shoe form is lowered by a hydraulic mechanism for example so as to pressure the concrete. The concrete is thus molded (step 140).

When the concrete is ready for unmolding (step 150), the shoe form is removed either vertically or laterally. Then the closed form is lifted, thereby defining rows of concrete blocks as shown in FIGS. 5 and 6, before the base is in turn laterally removed by a horizontal movement. The horizontal movement of the shoe form and of the base respectively imprint a profile on the top and on the bottom of the rows as shown in FIG. 5 for example, which is a repetition of sequences corresponding to blocks separated by notches. Finally, by breaking off the rows at the location of the notches, individual blocks are separated.

From the foregoing, it should now be apparent that the present invention provides a mold and a method that allow fabricating chamfered concrete blocks in a vertical position. Interestingly, the concrete blocks thus fabricated offer a number of advantages over concrete blocks currently fabricated in the art.

In particular, as mentioned hereinabove, they allow a reduced weight and use of material due to their shape (better seen in FIG. 2).

Moreover, the shape of these blocks proves to allow versatile uses, as can be understood from FIGS. 8 to 10.

For example, such blocks may be used to erect a straight wall, as illustrated in FIG. 8. As seen from above, the wall 200 is made of a number of blocks 210 located side by side along opposite side faces 212 and 214. Because of the specific shape of each block 210, two adjacent blocks 210 are in contact only at a location of a rim 216 and at a point 218 at a far rear end face thereof, thereby forming a channel 220 running vertically all the way along a height of the wall 200 while forming a continuous front face 222 and a continuous rear face 224. The skilled artisan knows how blocks 210 are superimposed one on top of the other along faces thereof provided with recess channels 226 allowing a connecting rod (not shown) to be inserted for holding them together.

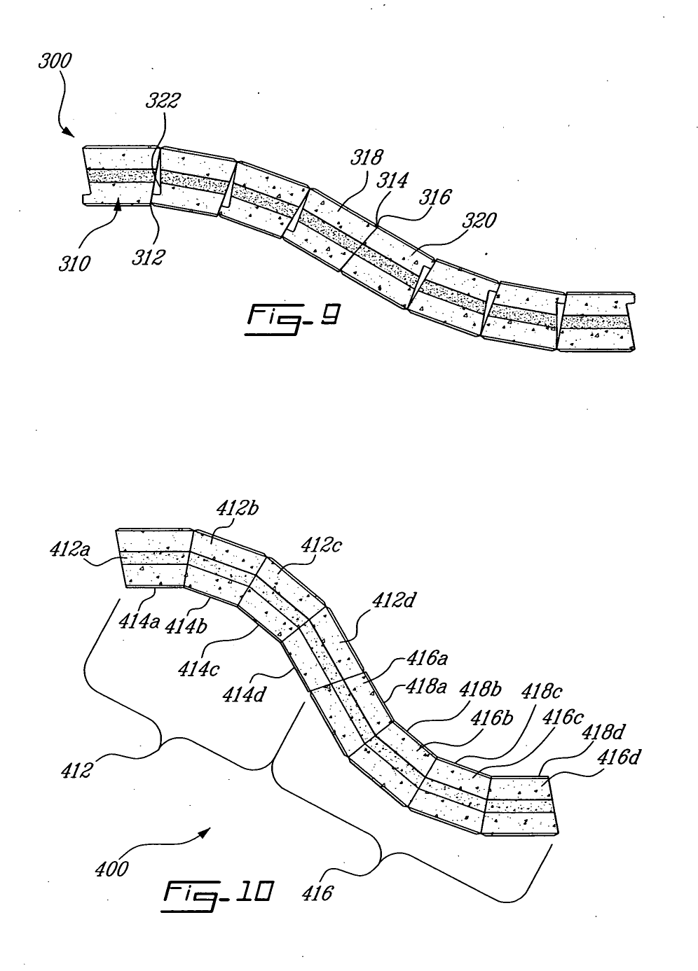

Turning now to FIG. 9, it is shown that a slightly curved wall 300 may be erected by breaking, alternatively, depending of a desired curvature, a rim 312 of one block 310 or both opposite rims 314, 316 of two adjacent blocks 318 and 320. In the former case, a channel 322 remains and runs vertically all the way along a height of the wall 300, whereas in the latter case, the adjacent blocks 318 and 320 are in contact along a full surface all the way along a height of the wall 300.

In the event that a wall with a definite curvature is needed, it may be contemplated to break off systematically both the opposite rims of two adjacent blocks, to yield a wall 400 as illustrated in FIG. 10. As can be seen in a first portion 412 of the wall 400, four blocks 412a, 412b, 412c and 412d that have both rims on their respective adjacent side faces broken off, are laid adjacent to one another along these side faces with their front face 414a, 414b, 414c and 414d generally facing a first direction. Then a fifth block 416a, which also has both rims on its side faces broken off, is laid adjacent the last block 412d of the first portion 412 of the wall 400 with its front face 418a facing a second direction generally opposite the first direction, thereby creating an inflection point of the wall 400. Further blocks 416b, 416c and 416d are disposed with their front face 418b, 418c and 418d facing the same second direction in a second portion 416 of the wall 400.

People in the art will appreciate that a number of ways of varying frequency of alternating a general direction toward which face the front sides of the blocks of the present invention are allowed, thereby allowing a large variety of wall designs, while the method of fabricating these blocks according to the present invention ensures that the height thereof is within a controlled tolerance.

Although the present invention has been described hereinabove by way of specific embodiments thereof, it can be modified, without departing from the spirit and nature of the subject invention as defined in the appended claims.

What is claimed is:

1. A precast block for the construction of retaining walls molded in a vertical position, said block comprising a width formed between a base and a forming shoe, a height formed between fixed opposite walls of a mold.

2. A precast block according to claim 1, wherein said block comprises a top face and a bottom face of a generally trapezoidal shape, said top face and said bottom face having a width decreasing from a nominal width w of said block at a rear end surface thereof to a reduced width w′ at an edge of a rim extending to a front end surface of said block and having a length corresponding to said nominal width w of the block.

3. A precast block according to claim 2, wherein said generally trapezoidal shape allows for vertical channels running between adjacent columns of a plurality of said block stacked one on top of the other.

4. A precast block according to claim 3, wherein each one of said top face a bottom face are further provided with at least one elongated connector receiving recess imprinted by a mesh of said mold.

5. A precast block according to claim 2, wherein when two of said block are adjacently mounted along their respective said rims a vertical channel is formed therebetween.

6. A precast block according to claim 5, wherein said two adjacent blocks are columns of adjacently mounted blocks 30 are in contact only at a location of their respective said rims and at a point at their respective near end surfaces.

7. A precast block according to claim 5, wherein each one of said top face a bottom face are further provided with at least one elongated connector receiving recess imprinted by a mesh of said mold.

8. A precast block according to claim 1, wherein said block comprises cemententious material.

9. A precast block according to claim 1, wherein said block comprises concrete.

10. A concrete block comprising:
a top face and a bottom face of a generally trapezoidal shape, said top face and said bottom face having a width decreasing from a nominal width w of said block at a rear end surface thereof to a reduced width w′ at an edge of a rim extending to a front end surface of said block and having a length corresponding to said nominal width w of the block.

11. A precast block according to claim 10, wherein said generally trapezoidal shape allows for vertical channels running between adjacent columns of a plurality of said block stacked one on top of the other.

12. A precast block according to claim 11, wherein each one of said top face a bottom face are further provided with at least one elongated connector receiving recess imprinted by a mesh of said mold.

13. A precast block according to claim 10, wherein when two of said block are adjacently mounted along their respective said rims a vertical channel is formed therebetween.

14. A precast block according to clam 13, wherein said two adjacent blocks are columns of adjacently mounted blocks 30 are in contact only at a location of their respective said rims and at a point at their respective near end surfaces.

15. A precast block according to claim 13, wherein each one of said top face a bottom face are further provided with at least one elongated connector receiving recess imprinted by a mesh of said mold.

16. A precast block according to claim 10, wherein said block comprises cemententious material.

17. A precast block according to claim 10, wherein is block comprises concrete.

18. A mold for molding block, said mold comprising:
a mobile base member;
a mobile intermediate closed form for positioning on said base member so as to receive concrete therein, said intermediate closed form including opposite walls; and
a mobile top member opposite said base member for positioning on said intermediate closed form so as to apply pressure to concrete contained therein;
whereby, when said intermediate closed form is positioned on said base member and contains concrete therein with said top member positioned thereon and when the concrete cools down, concrete blocks are formed of a width defined between said top member and said base member and of a height defined by said closed form opposite walls.

19. A mold according to claim 18, wherein said base member and said top member include respective inner surfaces so configured as to determine the width of the blocks.

20. A mold according to claim 19, wherein at least one of each said inner faces includes at least one horizontally retractable rod for forming at least one channel on faces of the concrete blocks separated by said width.

21. A mold according to claim 19, wherein said inner surfaces have a determined chamfered geometry for imprinting a corresponding determined chamfered geometry onto faces of said concrete blocks

22. A mold according to claim 18, wherein said mobile intermediate closed form includes an inner surface having a geometry defining a mesh of rows of concrete forms separated by notches.

23. A method for molding a concrete construction block for the construction of retaining walls in a vertical position, comprising
(a) providing a base and a shoe form;
(b) sitting a fixed closed form onto the base;
(c) molding concrete into the fixed closed form onto the base; and
(d) unmolding.

24. A method according to claim 23, wherein said (a) comprises providing a base and a shoe form having an inner surface thereof so as to imprint a desired chamfered shape.

25. A method according to claim 23, wherein said both base and a shoe form are movable in a generally horizontal plane.

26. The method according to claim 23, wherein said (b) comprises providing a fixed closed form having a mesh comprising lateral walls of a mold comprising the base and the shoe form together with the closed form, and inner walls defining rows of blocks to be molded.

27. A method according to claim 23, wherein said (c) comprises:
pouring concrete into the fixed closed form onto the base;
lowering the shoe to pressure the concrete;
curing; and
cooling down.

28. The method according to claim 23, wherein said (d) comprises:
laterally removing the shoe form by horizontal movement;
lifting the closed form;
laterally removing the base by an horizontal movement; and
breaking off the formed concrete into blocks.

29. A method according to claim 28 wherein said lifting the closed form imprints rows of concrete blocks in the concrete.

30. A method according to claim 28, wherein said said laterally removing the shoe form and said laterally removing the base respectively imprint sequences corresponding to blocks separated by notches on a top and on a bottom of the rows.

31. A method according to claim 29, wherein said said laterally removing the shoe form and said laterally removing the base respectively imprint sequences corresponding to blocks separated by notches on a top and on a bottom of the rows.

32. A method according to claim 31 further comprising:
(e) breaking off the molded concrete into blocks.

33. A method according to claim 31 further comprising:
(e) breaking off the molded concrete into blocks.

34. A method according to claim 33, wherein said (e) comprises breaking off the rows at the location of the notches.
